(19) United States
(12) Patent Application Publication
(10) Pub. No.: US 2011/0108478 A1
(43) Pub. Date: May 12, 2011

(54) Hydrophilic Polyethersulfone Filtration Membrane, Process for Producing the Same, and Dope Solution

(75) Inventors: Koki Taguchi, Kobe-shi (JP); Kenichiro Igashira, Akashi-shi (JP); Osamu Muragishi, Kakogawa-shi (JP); Hideto Matsuyama, Kyoto-shi (JP); Takashi Nishino, Kobe-shi (JP)

(73) Assignee: KAWASAKI JUKOGYO KABUSHIKI KAISHA, Kobe (JP)

(21) Appl. No.: 12/937,183

(22) PCT Filed: Apr. 9, 2009
(86) PCT No.: PCT/JP2009/001656

§ 371 Date: Dec. 20, 2010

(30) Foreign Application Priority Data
Apr. 11, 2008 (JP) 2008-104036

(51) Int. Cl. B01D 71/68; B01D 71/82; C08L 81/06; C08J 9/26

(52) U.S. Cl. 210/500.33; 524/609; 524/508; 264/49

(57) ABSTRACT

A hydrophilic filtration membrane having high chemical resistance, high strength, high water permeability and high blocking performance, and being superior in fouling resistance is provided. A hydrophilic filtration membrane containing a hydrophilic polyethersulfone having a contact angle of 65 to 74 degree, a molecular weight of 10,000 to 100,000, and the number of hydroxy groups of 0.6 to 1.4 per 100 polymerization repeating units. The hydrophilic filtration membrane may additionally contain a polyvinylpyrrolidone having a molecular weight of 10,000 to 1,300,000.

### TECHNICAL FIELD

The present invention relates to a hydrophilic filtration membrane made from a polyethersulfone, a process for production, and a dope solution. More particularly, the present invention relates to a hydrophilic filtration membrane made from a polyethersulfone, and a process for production of the same and a dope solution suited for use in the field of water treatments involving beverage (drinking water) manufacturing, water purification treatment and waste water treatment, as well as medical field, food engineering field, and the like.

### BACKGROUND ART

In recent years, filtration membranes (separation membranes) are utilized in a variety of areas such as the field of water treatments involving beverage manufacturing, water purification treatment and waste water treatment, as well as food industry field, and the like. Filtration membranes have been utilized for eliminating impurities in water as an alternative to conventional sand filtration or coagulating sedimentation process in the field of water treatments involving beverage manufacturing, water purification treatment, waste water treatment and the like. Moreover, in the food engineering field, filtration membranes have been utilized for the purpose of concentrating liquids, and separating and eliminating yeast etc., used in fermentation.

Since the quantity of treated water with filtration membranes used in various ways as described above is large in the field of water treatments such as water purification treatment and waste water treatment, improvement of water permeability has been demanded. Superior water permeability enables the membrane area to be decreased, and thus compact apparatuses can be provided to permit cost reduction of equipment, leading to advantages in terms of costs for replacing the membrane as well as the area of equipment.

Additionally, in waste water treatments, a microbicide such as sodium hypochlorite is charged into a membrane module portion for the purpose of sterilizing charged water and preventing biofouling of the membrane. Furthermore, since the membrane itself is washed with an acid, an alkali, chlorine, a surfactant etc., filtration membrane requires chemical resistance properties.

Moreover, in production of tap water, troubles of contamination of treated water with pathogenic microorganisms that are resistant to chlorine such as cryptosporidium, derived from feces and urine of livestocks and the like are not dealt with in a water purifying plant have elicited since 1990s. Thus, for preventing such troubles, sufficient separation characteristics so as to avoid contamination of treated water with the raw water, and great physical strength have been required for filtration membranes.

Therefore, filtration membranes require superior blocking performance, chemical resistance, physical strength, water permeability and fouling resistance. Thus, filtration membranes produced using a polyvinylidene fluoride based resin having both chemical resistance and physical strength in combination have been used. However, since filtration membranes produced using a polyvinylidene fluoride based resin is hydrophobic, fouling substances are likely to be attached to pores of the filtration membrane, and thus washing with a chemical such as sodium hypochlorite must be frequently carried out. Therefore, lifetime of the membrane is shortened, and the frequency of replacement of the membrane is increased, leading to a problem of high running costs. In addition, since filtration membranes produced using a polyvinylidene fluoride based resin contain halogen molecules, environmental endocrine disrupters are generated upon incineration for disposal, which may lead to problems of great environmental burden.

On the other hand, cellulose based resins have attracted attention in addition to polyvinylidene fluoride based resins. Cellulose based resins are more hydrophilic as compared with polyvinylidene fluoride, and is advantageous in high fouling resistance. Additionally, since halogen is not contained, it is advantageous in less environmental burden. However, it is disadvantageous in low physical strength.

Furthermore, a polyethersulfone (hereinafter, may be abbreviated as “PES”) is noteworthy as a compound that exhibits intermediate characteristics of polyvinylidene fluoride based resins and cellulose based resins in both terms of physical strength and fouling resistance (for example, see Patent Documents 1 to 3). However, even when a polyethersulfone is used as a filtration membrane, hydrophilicity of the membrane itself is still insufficient, and a filtration membrane which is satisfactory in light of fouling resistance has not been obtained under current circumstances.

### PRIOR ART DOCUMENTS

### Patent Documents

Patent Document 1: Japanese Unexamined Patent Application,
Publication No. 2006-81970 (Claim 1)
Patent Document 2: Japanese Unexamined Patent Application, Publication No. H7-163847 (Claim 1)
Patent Document 3: Japanese Unexamined Patent Application (Translation of PCT Application), Publication No. 2002-512876 (paragraph [0015])

### SUMMARY OF THE INVENTION

### Problems that the Invention is to Solve

An object of the present invention is to provide a hydrophilic filtration membrane that is superior in blocking performance, chemical resistance, physical strength and water permeability, and is also superior in fouling resistance.

### Means for Solving the Problems

The hydrophilic filtration membrane made from a polyethersulfone of the present invention is characterized by containing a hydrophilic polyethersulfone having a contact angle of 65 to 74 degree. In other words, hydrophilization of the hydrophilic polyethersulfone in the present invention is permitted by, for example, introduction of a hydroxy group at the end of a polyethersulfone or the like.

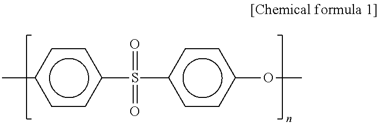

The number of hydroxy groups in the hydrophilic polyethersulfone is preferably 0.6 to 1.4 per 100 polymerization repeating units. Furthermore, the hydrophilic polyethersulfone has a molecular weight of preferably in the range of 10,000 to 100,000.

The hydrophilic filtration membrane of the present invention may further contain a polyvinylpyrrolidone (poly(N-vinyl-2-pyrrolidone)). Herein, the polyvinylpyrrolidone used in the present invention preferably has a molecular weight in the range of 10,000 to 1,300,000.

Since a hydrophilic polyethersulfone is used in the hydrophilic filtration membrane of the present invention, compatibility of the polyvinylpyrrolidone with the polyethersulfone is improved, whereby the polyvinylpyrrolidone that is intrinsically water soluble is not easily eluted from the filtration membrane. In other words, since a hydrophilic compound has not been used as the polyethersulfone in producing conventional filtration membranes, a polyvinylpyrrolidone is not compatible with a polyethersulfone, and has been merely added as a pore-opening agent for forming holes by allowing for elution during membrane production, as disclosed in Patent Document 1 described above. On the other hand, in the present invention, the polyvinylpyrrolidone is miscible with the hydrophilic polyethersulfone and retained in the filtration membrane, whereby a function of significantly improving hydrophilicity of the filtration membrane is undergone.

The dope solution of the present invention is characterized by containing the aforementioned hydrophilic polyethersulfone having a contact angle of 65 to 74 degree, and a solvent. The number of hydroxy groups in the hydrophilic polyethersulfone is preferably 0.6 to 1.4 per 100 polymerization repeating units, and the molecular weight is preferably in the range of 10,000 to 100,000.

Moreover, the solvent in the dope solution of the present invention is preferably an organic solvent that allows the hydrophilic polyethersulfone to be dissolved, and is miscible with water.

The dope solution of the present invention may further contain a polyvinylpyrrolidone (poly(N-vinyl-2-pyrrolidone)) in order to improve hydrophilicity of the resultant filtration membrane. This polyvinylpyrrolidone preferably has a molecular weight in the range of 10,000 to 1,300,000. The solvent in the dope solution of the present invention is preferably an organic solvent that allows the hydrophilic polyethersulfone to be dissolved, and is miscible with water, and is more preferably an organic solvent that allows the hydrophilic polyethersulfone and the polyvinylpyrrolidone to be dissolved, and is miscible with water.

The process for producing the hydrophilic filtration membrane of the present invention is characterized in that a filtration membrane is obtained by a nonsolvent-induced phase separation process using the aforementioned dope solution. More specifically, the solvent of the dope solution is removed by pouring the dope solution poured into a membrane production bath solution that serves as a nonsolvent for the hydrophilic polyethersulfone to form a porous membrane. The membrane production bath solution is preferably water in light of the cost and the like; therefore, the solvent of the dope solution is preferably an organic solvent that allows the hydrophilic polyethersulfone, to be dissolved and is miscible with water.

In the process for producing the hydrophilic filtration membrane of the present invention, a hydrophilic filtration membrane in the form of a flat membrane is obtained by discharging the dope solution from above the liquid level or into the liquid of the membrane production bath solution to give a form of a membrane using a discharge nozzle. Alternatively, a hydrophilic filtration membrane in the form of a hollow fiber membrane is obtained by discharging the dope solution from above the liquid level or into the liquid of the membrane production bath solution to give a hollow fiber form using a multi-discharge nozzle, and concurrently discharging an internal diameter-maintaining liquid from the center section of the multi-discharge nozzle into the center section of the hollow fiber.

Additionally, in the process for producing the hydrophilic filtration membrane of the invention of the present application, the hydrophilic filtration membrane is preferably reinforced with a reinforcing fiber. Namely, in the case of a hydrophilic filtration membrane in the form of a flat membrane, the intended membrane is obtained by discharging a dope solution together with a reinforcing fiber into a membrane production bath solution upon discharging the dope solution into a form of a membrane. Alternatively, in the case of a hydrophilic filtration membrane in the form of a hollow fiber membrane, the intended membrane is obtained by discharging a dope solution together with a hollow reinforcing fiber from above the liquid level or into the liquid of the membrane production bath solution.

### Effects of the Invention

The hydrophilic filtration membrane of the present invention is one that is superior in the physical strength and chemical resistance, and also has high fouling resistance, since a hydrophilic polyethersulfone prepared to be hydrophilic while maintaining various characteristics of the polyethersulfone is used. In particular, the hydrophilic filtration membrane strengthened using a reinforcing fiber becomes extremely superior in light of the physical strength.

Additionally, since the hydrophilic filtration membrane containing a polyvinylpyrrolidone of the present invention has high compatibility of the polyvinylpyrrolidone with the hydrophilic polyethersulfone, the polyvinylpyrrolidone is likely to remain in the filtration membrane without elution from the filtration membrane even during the membrane production, leading to significant increase of the hydrophilicity of the filtration membrane, and thus a filtration membrane that is superior in fouling resistance can be obtained. Therefore, by using the hydrophilic filtration membrane of the present invention, the frequency of washing of the separation membrane decreases, and product life time is prolonged. Thus, providing an innovative technique for producing a separation membrane that achieves low running costs is enabled.

### BRIEF DESCRIPTION OF THE DRAWINGS

FIG. 1 shows a view illustrating schematic configuration of a spinning apparatus for producing a hollow fiber membrane according to a solvent-induced phase separation process.

In FIG. 2, FIG. 2 (a) shows a cross sectional view illustrating a multi-discharge nozzle 3, and FIG. 2 (b) shows a bottom view illustrating a center portion of the bottom of the multi-discharge nozzle 3 shown in FIG. 2 (a).

FIG. 3 shows a view illustrating a schematic configuration of an apparatus for conducting a fouling resistance test of a hollow fiber membrane.

In FIG. 4, FIGS. 4 (a) and (b) show pipings of a module shown in FIG. 3 in sewage filtration and reverse cleaning, respectively.

FIG. 5 shows a view illustrating test results obtained when the procedures of filtration and reverse cleaning were repeated until the transmembrane pressure difference became about 150 kPa.

FIG. 6 shows a micrograph illustrating a cross-sectional surface of a hollow fiber membrane of Example 1.

FIG. 7 shows a micrograph of the surface of the hollow fiber membrane of Example 1.

FIG. 8 shows a micrograph illustrating a cross-sectional surface of a hollow fiber membrane of Example 3.

FIG. 9 shows a micrograph of the surface of the hollow fiber membrane of Example 3.

FIG. 10 shows a schematic view illustrating an apparatus for testing the amount of water permeation.

FIG. 11 shows a schematic configuration diagram for producing a hollow fiber membrane reinforced with a reinforcing fiber.

In FIG. 12, FIG. 12 (a) shows a detailed perspective view of the discharge nozzle shown in FIG. 11, and FIG. 12 (b) shows a cross sectional view illustrating the vicinity of a spinning discharge opening of the discharge nozzle.

FIG. 13 shows a micrograph of the surface of a hollow fiber membrane of Example 4.

In FIG. 14, FIG. 14 (a) shows an electron micrograph of a cross-sectional surface of the hollow fiber membrane of Example 4, FIG. 14 (b) shows an enlarged electron micrograph of a rectangle area indicated by a solid line in FIG. 14 (a), and FIG. 14 (c) shows an enlarged electron micrograph of a rectangle area indicated by a solid line in FIG. 14 (b).

FIG. 15 shows a schematic view for facilitating understanding of the photograph shown in FIG. 14 (a).

### DESCRIPTION OF NUMERICAL REFERENCES

1 supplying pump of dope solution
2 dissolution bath
3 multi-discharge nozzle
4 supplying pump of internal diameter-maintaining liquid
5 internal diameter-maintaining liquid
6 air gap
7 membrane production bath solution
8 winding unit
9 dope solution
10 hollow fiber membrane
11 nozzle block
12 cavity
13 discharge opening
14 supplying tube of internal diameter-maintaining liquid
15 spinning discharge opening
16 internal diameter-maintaining liquid discharge opening
21 reinforcing fiber
22 bobbin
23 membrane production bath solution tank
24 membrane production bath solution
25 winding unit
26 spinning discharge opening
27 dope solution
28 air gap
30 module
31 hollow fiber membrane
31a airtight stopper
33 flowmeter
34 gear pump
35 sewage vessel
36 inlet tube
37 water distribution tube
37a airtight stopper
38 flowmeter
40 vessel
41 pump
42 flowmeter
50 rotary pump
51, 52 pressure gauge
51a, 51b injection needle
53 hollow fiber membrane

### PREFERRED MODE FOR CARRYING OUT THE INVENTION

Embodiments of the present invention will be explained below, but the present invention is not limited to the following embodiments.

In the present invention, a hydrophilic polyethersulfone having a contact angle of 65 to 74 degree, preferably a contact angle of 65 to 70 degree is used as the polyethersulfone. In general, a polyethersulfone has a contact angle of 85 to 90 degree, and the hydrophilic polyethersulfone having such a small contact angle as described above is produced by, for example, introducing a hydroxy group into the end of a polyethersulfone. As such a hydrophilic polyethersulfone, “SUMIKA EXCEL 5003PS” (manufactured by Sumitomo Chemical Co., Ltd.) may be exemplified.

The number of hydroxy groups in the hydrophilic polyethersulfone is preferably 0.6 to 1.4 per 100 polymerization repeating units, and more preferably in the range of 0.8 to 1.2. When the number of hydroxy groups is less than 0.6 per 100 polymerization repeating units, hydrophilicity of the filtration membrane is lowered to deteriorate the fouling resistance. In addition, a polyethersulfone having the number of hydroxy groups of greater than 1.4 per 100 polymerization repeating units is inferior in chemical stability upon treatments such as cleaning with a chemical.

Moreover, the hydrophilic polyethersulfone has a molecular weight of preferably in the range of 10,000 to 100,000, and more preferably in the range of 40,000 to 80,000. When the molecular weight is lower than 10,000, physical strength of the filtration membrane becomes deficient, leading to difficulty in membrane production. Whereas, those having a molecular weight of higher than 100,000 are hardly available in substance.

The hydrophilic filtration membrane of the present invention may further contain a polyvinylpyrrolidone (poly(N-vinyl-2-pyrrolidone)). The molecular weight of the polyvinylpyrrolidone is preferably in the range of 10,000 to 1,300,000, and more preferably in the range of 40,000 to 800,000. The molecular weight of the polyvinylpyrrolidone being lower than 10,000 is not appropriate since the polyvinylpyrrolidone is more likely to be eluted, and a phenomenon of forming air holes of the membrane occurs. Whereas, those having a molecular weight of higher than 1,300,000 are hardly available in substance.

When the filtration membrane contains the polyvinylpyrrolidone, the content is up to 200 parts by weight, and preferably up to 150 parts by weight relative to 100 parts by weight of the hydrophilic polyethersulfone. The content exceeding 200 parts by weight is not preferred since the strength as a filtration membrane cannot be maintained.

The dope solution of the present invention contains the aforementioned hydrophilic polyethersulfone having a contact angle of 65 to 74 degree, and a solvent. It is necessary that the solvent in the dope solution allows the hydrophilic polyethersulfone to be dissolved, and is miscible with a nonsolvent in the membrane production bath solution for use in producing the filtration membrane. In particular, when the membrane production bath solution containing water is used, the solvent in the dope solution must be an organic solvent that allows the hydrophilic polyethersulfone to be dissolved, and is miscible with water. Examples of such a solvent include dimethylsulfoxide (DMSO), 1-methyl-2-pyrrolidone (NMP), dimethylformamide (DMF), dimethylformamide (DMF), and dimethylacetamide (DMAc).

Furthermore, the dope solution of the present invention may further contain the aforementioned polyvinylpyrrolidone. When the polyvinylpyrrolidone is blended, the solvent must allow not only the hydrophilic polyethersulfone but also the polyvinylpyrrolidone to be dissolved. Examples of such a solvent include dimethylsulfoxide (DMSO), 1-methyl-2-pyrrolidone (NMP), dimethylformamide (DMF), and dimethylacetamide (DMAc).

The concentration of the hydrophilic polyethersulfone in the dope solution of the present invention is preferably in the range of 5 to 40% by weight, and more preferably in the range of 15 to 25% by weight. Furthermore, when the dope solution contains the polyvinylpyrrolidone, the concentration of the polyvinylpyrrolidone is preferably in the range of 1 to 15% by weight, and more preferably in the range of 5 to 10% by weight.

Still further, to the dope solution of the present invention may be added a pore-opening agent for forming through-holes during the production of the filtration membrane by eluting into the membrane production bath solution. Illustrative examples of such a pore-opening agent include polyethylene glycol (PEG 200 to PEG 4000), and the like.

Also, to the dope solution of the present invention may further added an inorganic salt such as LiCl, as well as a surfactant such as a polyoxyethylene-polyoxypropylene surface active block copolymer (trade name Pluronic F-127, Basf Japan Ltd.). These additives have effects of changing the electrical state of the dope solution, and concomitantly enhancing the amount of water permeation and the physical strength of the membrane in the production of the membrane.

The process for producing the hydrophilic filtration membrane of the present invention employs a nonsolvent-induced phase separation process. More specifically, the filtration membrane is obtained by charging the dope solution into a membrane production bath solution to be a nonsolvent for the hydrophilic polyethersulfone. Herein, it is necessary to use a membrane production bath solution which is a nonsolvent for the hydrophilic polyethersulfone, namely, which does not allow the hydrophilic polyethersulfone to be dissolved, and which is miscible with the solvent contained in the dope solution. When the aforementioned dimethylsulfoxide (DMSO), 1-methyl-2-pyrrolidone (NMP), dimethylformamide (DMF), dimethylacetamide (DMAc) or the like is used as the solvent of the dope solution, a membrane production bath solution containing water may be used as the membrane production bath solution. In light of the cost and the like, the membrane production bath solution is more preferably water.

The hydrophilic filtration membrane of the present invention can improve the physical strength by using a reinforcing fiber. The reinforcing fiber which may be used includes a glass fiber, a synthetic fiber, a semisynthetic fiber, a natural fiber or the like.

When the hydrophilic filtration membrane of the present invention is produced in the form of a flat membrane, a die or the like is used to discharge the aforementioned dope solution from above the liquid level or into the liquid of the membrane production bath solution using a discharge nozzle to give a form of a membrane, whereby a flat membrane is obtained. Accordingly, the solvent in the dope solution is removed into the membrane production bath solution, and as a result, the hydrophilic polyethersulfone insoluble in the membrane production bath solution is left as a porous filtration membrane. A hydrophilic filtration membrane in the form of a membrane reinforced with a reinforcing fiber can be obtained by feeding the reinforcing fiber concomitantly with discharging the dope solution in parallel from the discharge nozzle.

The hollow fiber membrane composed of the hydrophilic filtration membrane is produced according to the nonsolvent-induced phase separation process, by discharging the dope solution from above the liquid level or into the liquid of the membrane production bath solution to give a hollow fiber form using a multi-discharge nozzle, and concomitantly discharging an internal diameter-maintaining liquid from the center section of the multi-discharge nozzle to the center section of the hollow fiber. The internal diameter-maintaining liquid is used for allowing the hollow fiber membrane to maintain a hollow shape. As this internal diameter-maintaining liquid, a liquid similar to the membrane production bath solution may be used. The hydrophilic filtration membrane in the form of a hollow fiber reinforced using the reinforcing fiber is obtained without using the internal diameter-maintaining liquid, by discharging the dope solution from above the liquid level or into the liquid of the membrane production bath solution together with a hollow reinforcing fiber.

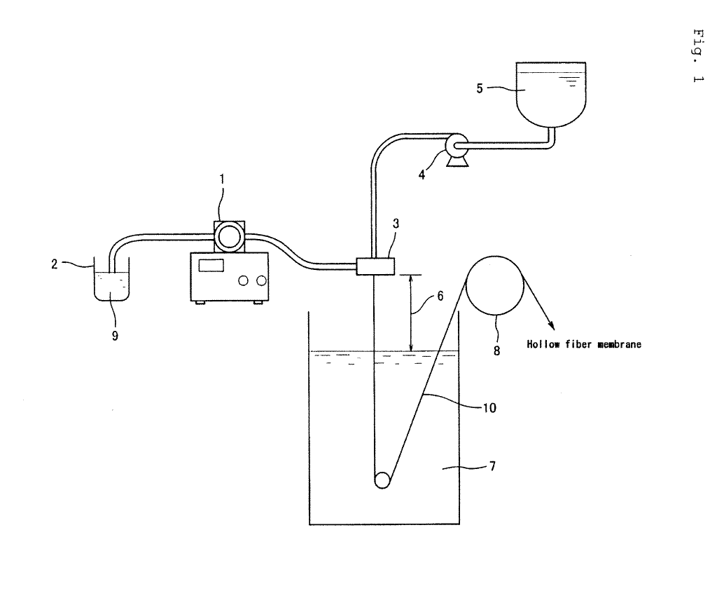

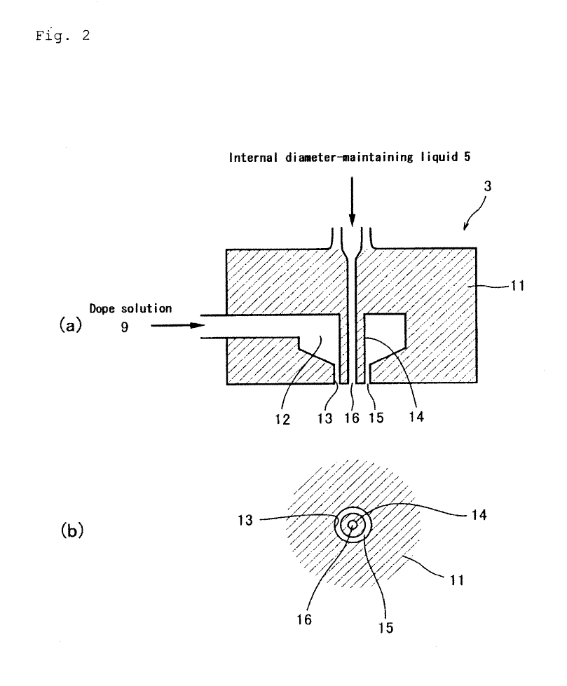

Production of the hollow fiber membrane according to a nonsolvent-induced phase separation process is conducted generally using a spinning apparatus as shown in FIG. 1. The spinning apparatus shown in this Figure has a dissolution bath 2 for reserving the dope solution 9 explained above, and a supplying pump of dope solution 1 for delivery of the dope solution 9. This supplying pump of dope solution 1 supplies the dope solution 9 to a multi-discharge nozzle 3. Additionally, an internal diameter-maintaining liquid 5 is supplied into the multi-discharge nozzle 3 from a supplying pump of internal diameter-maintaining liquid 4.

FIG. 2 (a) shows a cross section of the multi-discharge nozzle 3, and FIG. 2 (b) shows a center portion of the bottom view of the multi-discharge nozzle 3 shown in Fig. (a). As shown in FIG. 2 (a), the multi-discharge nozzle 3 has a nozzle block 11, and a cavity 12 is provided in the nozzle block 11. To this cavity 12 the dope solution 9 is supplied from the supplying pump of dope solution 1. Also, the cavity 12 opens to the inferior face of the nozzle block 11 as a discharge opening 13, and the discharge opening 13 is circular in a plan view as shown in FIG. 2 (b). Furthermore, a supplying tube of internal diameter-maintaining liquid 14 connected to the supplying pump of internal diameter-maintaining liquid 4 (see, FIG. 1) is disposed in the cavity 12. This supplying tube of internal diameter-maintaining liquid 14 reaches the center section of the discharge opening 13 through the cavity 12, and as shown in FIG. 2 (b), is fixed such that the center of the supplying tube of internal diameter-maintaining liquid 14 agrees with the center of the discharge opening 13. According to such a configuration, a spinning discharge opening 15 is formed between the discharge opening 13 and the supplying tube of internal diameter-maintaining liquid 14. In addition, a discharge opening of internal diameter-maintaining liquid 16 to which the internal diameter-maintaining liquid 5 is supplied by the aforementioned supplying pump of internal diameter-maintaining liquid 4 is formed at a central part of the supplying tube of internal diameter-maintaining liquid 14. Therefore, this multi-discharge nozzle 3 enables the internal diameter-maintaining liquid 5 to be discharged from the discharge opening of internal diameter-maintaining liquid 16 into the center section of the dope solution 9 discharged to give a hollow fibrous form from the spinning discharge opening 15. Accordingly, spinning of the hollow fiber membrane is enabled.

As shown in FIG. 1, the dope solution 9 and the internal diameter-maintaining liquid 5 discharged from the multi-discharge nozzle 3 reach into the membrane production bath solution 7. In this stage, an air gap 6 is present between the inferior face of the multi-discharge nozzle 3 and the liquid level of the membrane production bath solution 7 in FIG. 1, this air gap 6 may be no greater than 0 mm, namely, the inferior face of the multi-discharge nozzle 3 may exist below the liquid level of the membrane production bath solution 7.

The hollow fiber membrane 10 formed by nonsolvent-induced phase separation in the membrane production bath solution 7 is wound by a winding unit 8 (see, FIG. 1). In this step, the winding speed of the winding unit 8 may vary depending on the amount of supplying the stock solution for membrane production, the size of the spinning discharge opening 15 and the like, but is adequately 0.15 to 1.0 m/sec, in general. As the amount of supplying the stock solution for membrane production increases, and also as the size of the spinning discharge opening 15 is greater, it is necessary to accelerate the winding speed at the winding unit 8.

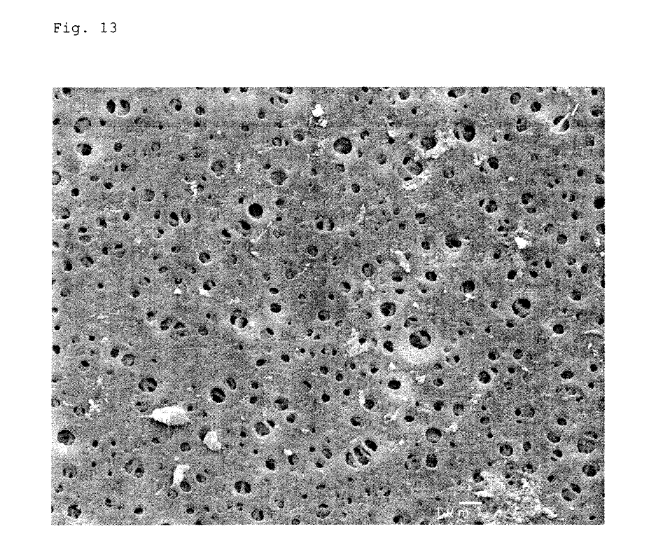

The hollow fiber membrane reinforced with the reinforcing fiber can be manufactured using an apparatus illustrated in the schematic configuration diagram shown in FIG. 11. The apparatus of the present embodiment has, as shown in this figure, a cylindrical discharge nozzle 20, and a bobbin 22 around which a tubular textile reinforcing fiber 21 is wound. A membrane production bath solution tank 23 reserving a membrane production bath solution 24 is provided below the discharge nozzle 20. In addition, this apparatus has a pulley provided in a membrane production bath solution tank 23, and a winding unit 25 for winding the obtained hollow fiber membrane.

FIG. 12 (a) shows a perspective view illustrating details of the discharge nozzle 20. As shown in this figure, the discharge nozzle 20 reserves a dope solution 27, and a spinning discharge opening 26 is provided on the bottom face of the discharge nozzle 20. The center section of the spinning discharge opening 26 is constructed such that the reinforcing fiber 21 supplied from the bobbin 22 is supplied. FIG. 12 (b) shows a cross sectional view illustrating the vicinity of the spinning discharge opening 26 of the discharge nozzle 20. As shown in this figure, the dope solution 27 is discharged from the spinning discharge opening 26, and concomitantly the reinforcing fiber 21 moves downward, whereby the dope solution 27 forms a coating layer on the external side of the reinforcing fiber 21. The coating layer of the dope solution 27 that covers the reinforcing fiber 21 causes nonsolvent-induced phase separation in the membrane production bath solution 24 in the membrane production bath solution tank 23 to form a hydrophilic filtration membrane. Thus, a hollow fiber membrane reinforced with the strong fiber substance is obtained. It is to be noted that an air gap 28 is present between the bottom face of the discharge nozzle 20 and the liquid level of the membrane production bath solution 24 in FIG. 11, this air gap 28 may be no greater than 0 mm, namely, the inferior face of the discharge nozzle 20 may exist below the liquid level of the membrane production bath solution 24. In addition, although the diameter of the spinning discharge opening 26, the external diameter of the reinforcing fiber 21, the external diameter and the membrane thickness of the intended hollow fiber membrane, the discharge velocity of the dope solution 27, and the like are factors which correlate with one another, in general: the diameter of the spinning discharge opening 26 is 1.2 to 3.0 mm; the external diameter of the reinforcing fiber 21 is 0.8 to 1.2 mm; the external diameter of the intended hollow fiber membrane is 1.25 to 3.0 mm and the membrane thickness thereof is 0.05 to 1.8 mm; and the winding speed is 0.02 to 0.67 m/sec.

### Example 1

A hydrophilic polyethersulfone (SUMIKA EXCEL 5003PS, manufactured by Sumitomo Chemical Co., Ltd., contact angle: 65 to 74 degree, number of hydroxy groups per 100 polymerization repeating units=0.89) was added to dimethylsulfoxide (manufactured by Wako Pure Chemical Industries, Ltd.) such that its concentration became 15% by weight, and the mixture was stirred for 24 hrs using a stirrer or the like to prepare a sufficiently homogenous solution. Thereafter, the mixture was maintained for 24 hrs, and the bubbles in the solution were sufficiently removed to obtain a dope solution.

This dope solution was used to conduct spinning of a hollow fiber membrane under conditions shown in Table 1 with the spinning apparatus shown in FIG. 1 according to a nonsolvent-induced phase separation process. It is to be noted that the measurement of the contact angle described later revealed that the hollow fiber membrane of this Example had a contact angle of 63 degree.

TABLE 1
Conditions for membrane production of hollow fiber membrane

| | | Examples 2 , 3 | | | |
|---|---|---|---|---|---|
| | | Comparative | | | |
| | □Example 1 | Examples 2, 3 | Example 4 | Example 5 | Example 6 |
| Diameter of spinning discharge opening (mm) | 1.0 | 1.0 | 2.0 | 2.0 | 2.0 |
| Diameter of internal diameter-maintaining | 0.7 | 0.7 | — | — | — |
| liquid discharge opening (mm) | | | | | |
| Liquid temperature of dope solution (deg c.) | 50 | 25 | 40 | 40 | 40 |
| Flow rate of dope solution (m/sec) | 0.16 | 0.12-0.13 | — | — | — |
| Internal diameter-maintaining liquid | water:DMSO = | water | — | — | — |
| | 1:1 | | | | |
| Flow rate of internal diameter-maintaining | 0.17 | 0.17 | — | — | — |
| liquid (m/sec) | | | | | |
| Liquid temperature of internal | 50 | 25 | — | — | — |
| diameter-maintaining liquid (deg c.) | | | | | |
| Winding speed (m/sec) | 0.16 | 0.13 | 0.04 | 0.04 | 0.03 |
| Air gap (mm) | 200 | 50 | 200 | 200 | 200 |
| Membrane production bath solution | water:DMSO = | water | water | water | water |
| | 1:1 | | | | |

### Comparative Example 1

A hollow fiber membrane of industrially available polyvinylidene fluoride (PVDF) was employed as Comparative Example 1.

### Example 2

A hydrophilic polyethersulfone (SUMIKA EXCEL 5003PS, manufactured by Sumitomo Chemical Co., Ltd.) and a polyvinylpyrrolidone (K30 (manufactured by Wako Pure Chemical Industries, Ltd.), molecular weight: 40,000) were added to dimethylsulfoxide (manufactured by Wako Pure Chemical Industries, Ltd.) such that their concentrations became 15% by weight and 1.25% by weight, respectively, to obtain dope solutions in a similar manner to Example 1.

Using this dope solution, a hollow fiber membrane was spun with the spinning apparatus shown in FIG. 1 according to a nonsolvent-induced phase separation process under conditions shown in Table 1.

### Comparative Example 2

A dope solution and a hollow fiber membrane were obtained by conducting a similar operation to that in Example 2 except that a usual polyethersulfone (E6020P, manufactured by BASF Japan Ltd., molecular weight: 50,000, contact angle: 85 to 90 degree, number of hydroxy groups per 100 polymerization repeating units=0) was used in place of the hydrophilic polyethersulfone.

### Example 3

A dope solution and a hollow fiber membrane were obtained by conducting a similar operation to that in Example 2 except that a polyvinylpyrrolidone (K90, (manufactured by Wako Pure Chemical Industries, Ltd.), molecular weight: 360,000) in an amount of 5% by weight was used in place of the polyvinylpyrrolidone (K30).

### Comparative Example 3

A dope solution and a hollow fiber membrane were obtained by conducting a similar operation to that in Example 3 except that a usual polyethersulfone (E6020P, manufactured by BASF Japan Ltd.) was used in place of the hydrophilic polyethersulfone.

### Example 4

A hydrophilic polyethersulfone (SUMIKA EXCEL 5003PS, manufactured by Sumitomo Chemical Co., Ltd.) and LiCl were dissolved in dimethylsulfoxide to give the concentrations of 15% by weight and 2% by weight, respectively, and a dope solution was obtained in a similar manner to Example 1. Using this dope solution, a hollow fiber membrane reinforced with a strong fiber substance was manufactured with the apparatus shown in FIG. 11. First, in this Example, the air gap 28 of 200 mm was provided, and the aforementioned dope solution was charged into the discharge nozzle 20 provided with the spinning discharge opening 26 having a diameter of 2.0 mmφ, and concomitantly a tubular textile made from a glass fiber (glass fiber tensile strength: about 0.3 kN) having an external diameter of 1.2 mm was passed through the central region of the discharge nozzle 20 to allow the dope solution to be coated on the surface of the tubular textile. The coating of the dope solution in this step had a thickness of 0.2 mm. Next, the tubular textile coated with the dope solution passed through the air gap 28, and the dope solution sufficiently infiltrated into the tubular textile during the passage. Subsequently, the tubular textile coated with the dope solution was passed through the membrane production bath solution tank 23 reserving the membrane production bath solution 24 of 40 degree C. to subject to a coagulation treatment. Next, the tubular textile was washed with a cleaning tank (not shown in the Figure), and thereafter wound with the winding unit 25 to obtain a hollow fiber membrane strengthened with the fiber of this Example. It should be noted that the winding speed of the winding unit 25 was 0.04 m/sec.

### Example 5

A dope solution was obtained in a similar manner to Example 1 except that a hydrophilic polyethersulfon and LiCl were dissolved in dimethylsulfoxide to give the concentrations of 12.5% by weight and 2% by weight, respectively. Using this dope solution, a hollow fiber membrane reinforced with the strong fiber substance was obtained in a similar manner to Example 4 with the apparatus shown in FIG. 11.

### Example 6

A hollow fiber membrane strengthened with the fiber was obtained in a similar manner to Example 5 except that the winding speed of the winding unit 25 was changed to 0.03 m/sec.

(Fouling Resistance Test)

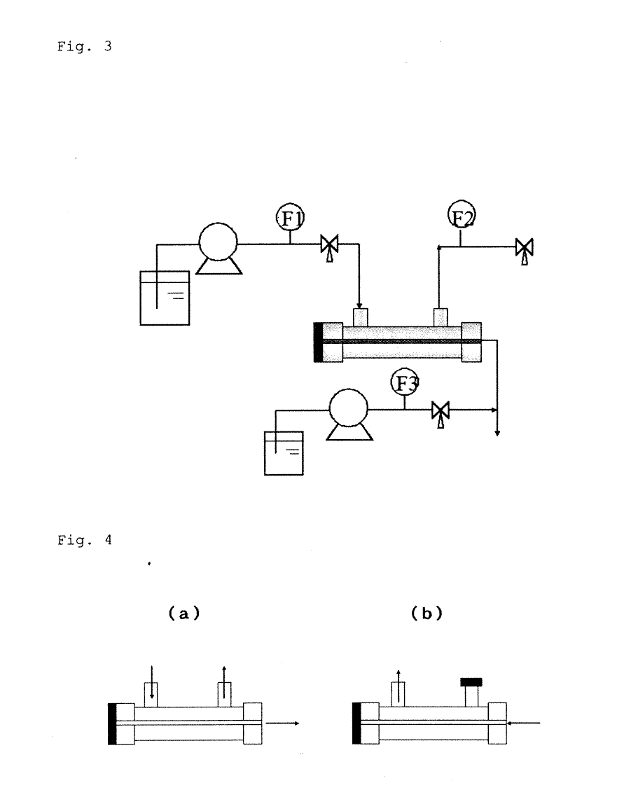

A fouling resistance test was conducted using the hollow fiber membrane of Example 1 and Comparative Example 1. FIG. 3 shows a schematic view illustrating the apparatus. This apparatus incorporates one hollow fiber membrane 31 produced as described above into the module 30, and the hollow fiber membrane 31 has a full length of 180 mm. One end of the module 30 is sealed with an airtight stopper 31a. Also, an inlet tube 36 for supplying the sewage, a valve 32, a flowmeter 33, a gear pump 34, and a sewage vessel 35 are serially connected to the one end of the module 30. A water distribution tube 37 for discharging the sewage failed to permeate the hollow fiber membrane 31 is connected to another end of the hollow fiber membrane 31, and the sewage is further discharged outside via a flowmeter 38 and a valve 39. On the other hand, clarified water that permeated the hollow fiber membrane 31 is discharged from another end of the module 30. Still further, this apparatus is provided with a vessel 40 for reserving cleaning water to be used for reverse cleaning, a pump 41 for supplying this cleaning water to the end of the hollow fiber membrane 31, a flowmeter 42 and a valve 43.

FIGS. 4 (a) and (b) show the module 30 illustrating the operations of sewage filtration and the reverse cleaning, respectively. As shown in FIG. 4 (a), during the filtration, the sewage is filtered by the hollow fiber membrane 31, and the clarified water filtered is obtained via the interior of the hollow fiber membrane 31, whereas the sewage failed to permeate the hollow fiber membrane 31 is discharged from another end of the module 30. On the other hand, during the reverse cleaning, an airtight stopper 37a is provided at the another end of the module 30, and the cleaning water is supplied from the interior of the hollow fiber membrane 31 through the membrane wall. Thus, contaminated substances attached to the external wall of the hollow fiber membrane 31 are detached and removed outside.

A fouling resistance test was conducted using the apparatus having the aforementioned construction. To the sewage in the sewage vessel 35 was added 20 ppm humic acid as a fouling substance, and the temperature of the mixture was kept at 25 degree C. The flow rate of the sewage was kept constant at 2.8 mL/min. The sewage was allowed to flow from the outside of the hollow fiber membrane 31 for 10 min, and the filtered water that had permeated the hollow fiber membrane 31 was collected, and the transmembrane pressure difference of the hollow fiber membrane 31 then was measured using a data logger (manufactured by KEYENCE Corporation, NR-1000) In addition, the elimination rate of the humic acid was calculated from the contents of humic acid in the sewage and the filtered water. The content of humic acid was determined using a UV spectrophotometer (manufactured by Hitachi, Ltd., U-200).

Next, cleaning water (25 degree C.) containing 5 ppm sodium hypochlorite was allowed to flow at a constant flow rate of 5.6 mL/min for 3 min to carry out reverse cleaning.

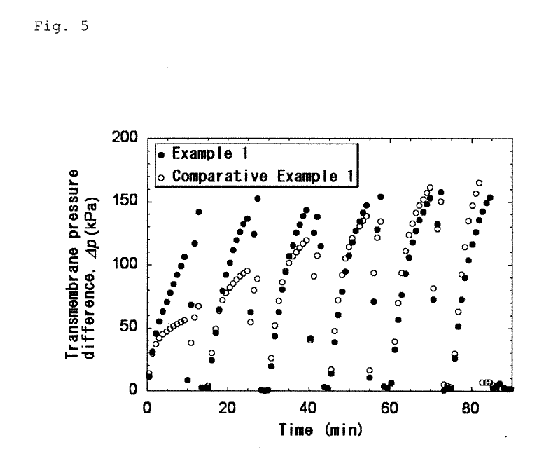

The foregoing procedures of the filtration and the reverse cleaning were repeated until the transmembrane pressure difference became about 150 kPa, and the results are shown in FIG. 5. Herein, the fouling resistance was evaluated on the basis of the gradient of the mean transmembrane pressure difference during the filtration (defined as “fouling substance accumulation rate”.).

As is clear from FIG. 5, both membranes were proven to exhibit increasing transmembrane pressure difference with time of the filtration. This finding was considered to result from the occurrence of clogging by incorporation of humic acid into the pores of the membrane, revealing that both membranes were deteriorated due to the humic acid. When Example 1 is compared with Comparative Example 1, recovery of the transmembrane pressure difference by the reverse cleaning was not found in Comparative Example 1, revealing more occurrence of clogging.

The fouling substance accumulation rates of the hollow fiber membranes of Example 1 and Comparative Example 1 were 0.8 kPa/h and 2.4 kPa/h, respectively, showing extremely smaller fouling substance accumulation rate of the hollow fiber membrane in Example 1 as compared with the value of the hollow fiber membrane in Comparative Example 1.

(Observation of Hollow Fiber Membrane Using Scanning Electron Microscope)

In order to obtain a hollow fiber membrane in the dry state, the hollow fiber membranes of Examples 1, 3 and 4 in the wet state were freeze-dried with a freeze drying apparatus (manufactured by EYELA, FD-1000). Observation samples were prepared by vapor deposition of Au/Pd by sputtering on: the surface and the cross-sectional surface of the freeze-dried hollow fiber membrane subjected to brittle fracture in liquid nitrogen in the case of Examples 1 and 3; and the surface of the freeze-dried hollow fiber membrane in the case of Example 4. The surface and the cross-sectional surface were observed with a scanning electron microscope (manufactured by JEOL Ltd. DATUM, JSM-7000F) under an accelerating voltage of 5 kV, at an applied electric current of 0.8 A. Moreover, the hollow fiber membrane of Example 4 was embedded using an epoxy resin for embedding (manufactured by Refinetech Co., Ltd.) after the freeze-drying, and then cut and polished on the face perpendicular to the longitudinal direction. Accordingly, the cross-sectional surface was observed with a scanning electron microscope.

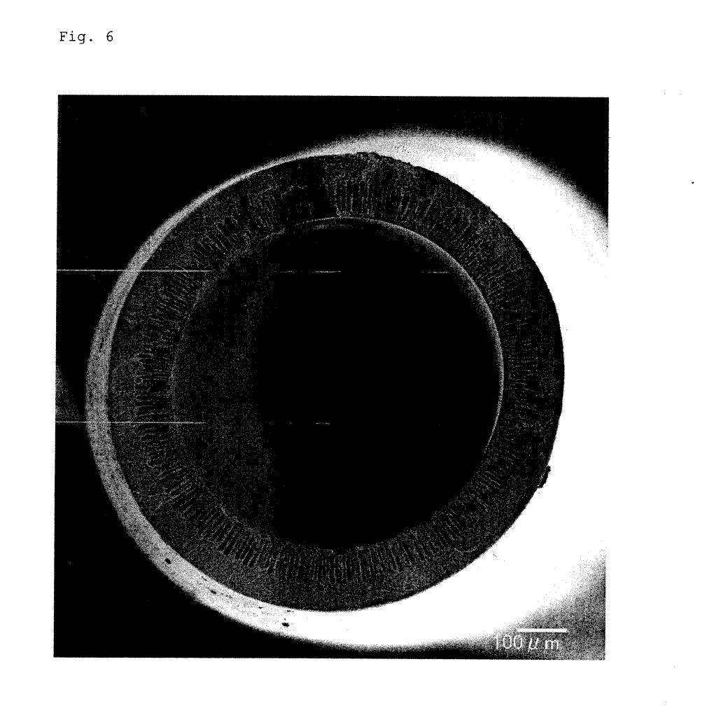

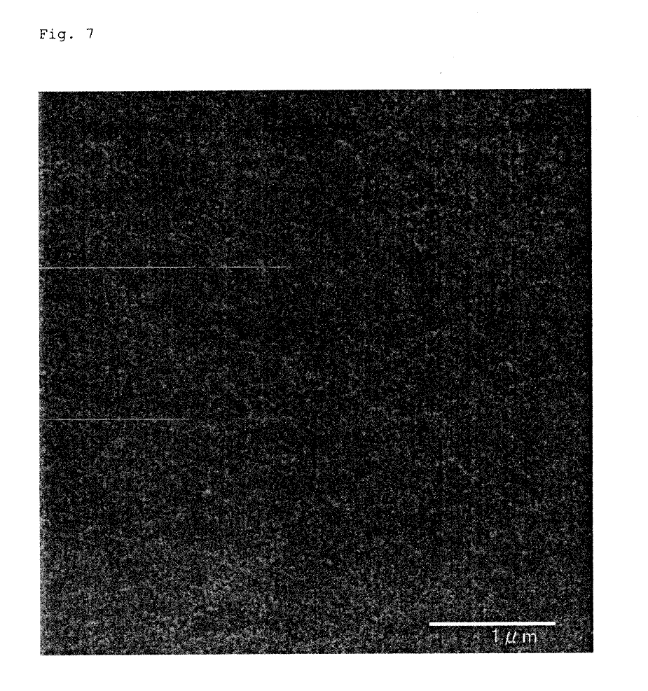

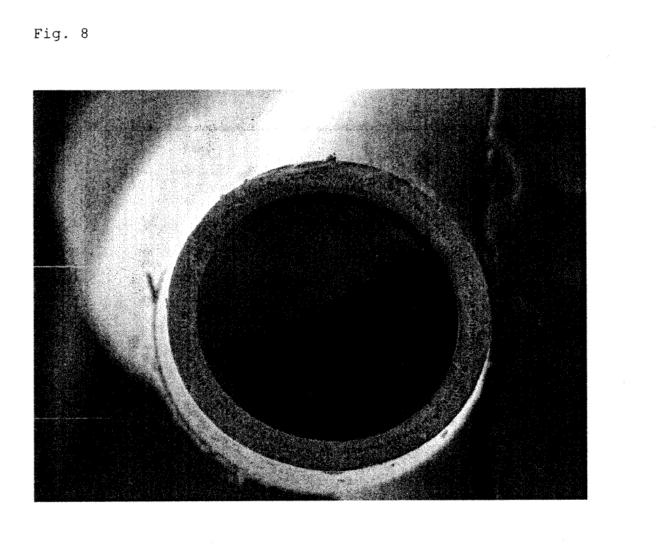

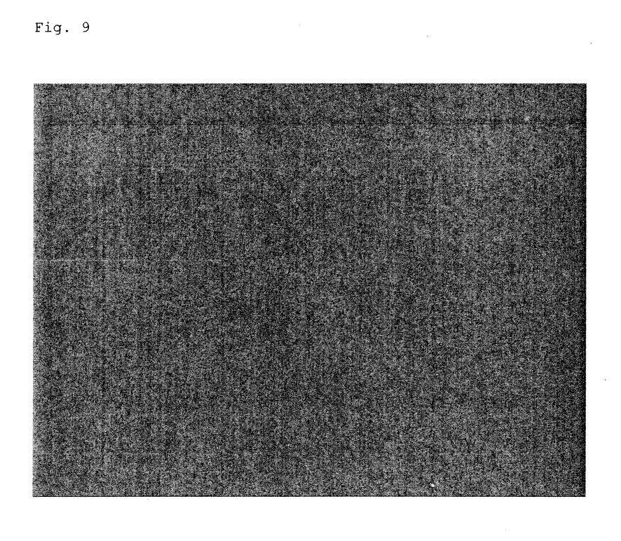

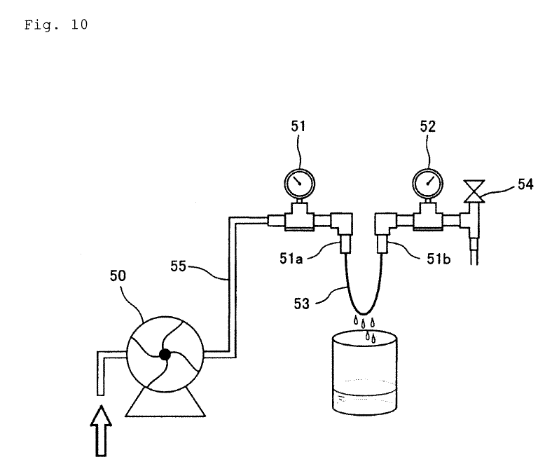

The electron micrographs of the cross-sectional surface and the surface of the hollow fiber membrane of Example 1 are shown in FIG. 6 and FIG. 7, respectively, and the electron micrographs of the cross-sectional surface and the surface of the hollow fiber membrane of Example 3 are shown in FIG. 8 and FIG. 9, respectively. From these photographs, it is proven that a porous structure was formed in the hollow fiber membranes of Examples 1 and 3.

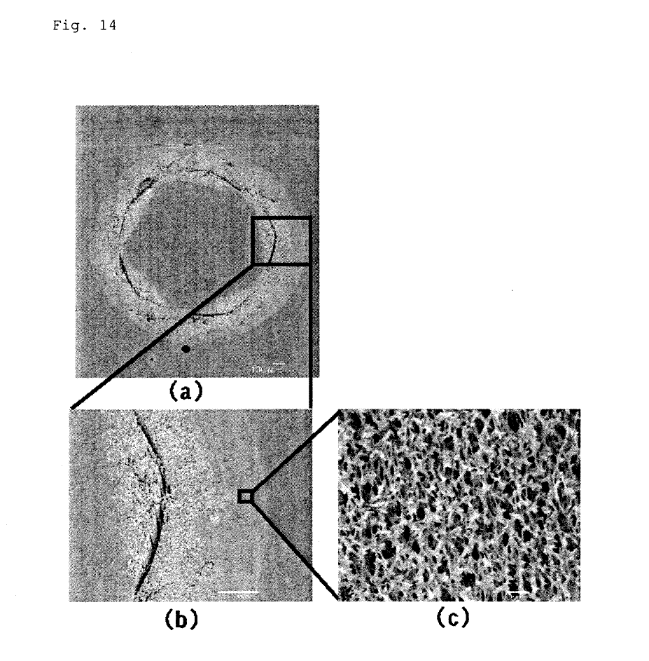

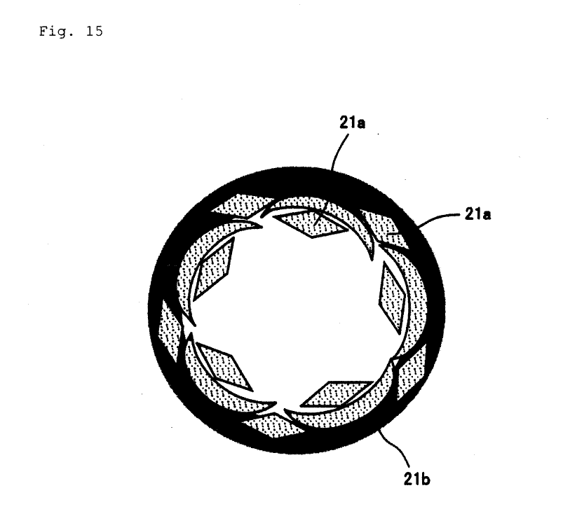

In addition, the electron micrographs of the surface and the cross-sectional surface of the hollow fiber membrane of Example 4 are shown in FIG. 13 and FIG. 14 (a), respectively. From FIG. 13, it is revealed that a large number of micropores having a pore size of 0.01 to 0.1 μm were formed on the surface of the hollow fiber membrane. FIG. 15 shows a schematically depicted view for facilitating understanding of the photograph shown in FIG. 14 (a). FIG. 14 (a) and FIG. 15 reveal that a glass fiber bundle 21a of the reinforcing fiber is present inside, and a high-molecular resin thin film 21b is coated on its external side. In these regards, FIG. 14 (b) shows an enlarged electron micrograph of a rectangle area indicated by a solid line in FIG. 14 (a), and FIG. 14 (c) shows an enlarged electron micrograph of a rectangle area indicated by a solid line in FIG. 14 (b). From these photographs, it is proven that the high molecular resin thin film 21b had a sponge structure in which a large number of micropores having a pore size of no greater than 10 μm were formed.

(Measurement of Contact Angle)

Using a contact angle measurement apparatus (manufactured by Kyowa Interface Science Co., LTD., DropMaster 300), contact angles of the polyethersulfone used in Examples 2 and 3, and Comparative Examples 2 and 3, as well as contact angles of water on the external surfaces of the hollow fiber membranes of Examples 2 and 3, and Comparative Examples 2 and 3 were measured. A droplet of 0.5 mL were placed dropwise on the external surface of the hollow fiber membrane using a certain injection needle, and the contact angle of the droplet was calculated by image processing using a camera attached to the apparatus. This operation was repeated 20 times for one sample, and the mean value of the 20-times measurement was determined as the contact angle of the sample. In order to avoid the measurement error due to permeation and evaporation of the droplet into the hollow fiber membrane, the time period between the placing of the droplet and the measurement by image processing was minimized to as short as possible. Table 2 shows the results of the measurement in connection with the performances of the hollow fiber membrane. These results reveal that the contact angles of the hollow fiber membranes of Examples 2 and 3 were lowered as compared with the contact angles of the hollow fiber membranes of Comparative Examples 2 and 3 which correspond to one another, suggesting that the polyvinylpyrrolidone remained in the membrane.

(Water Permeability Test)

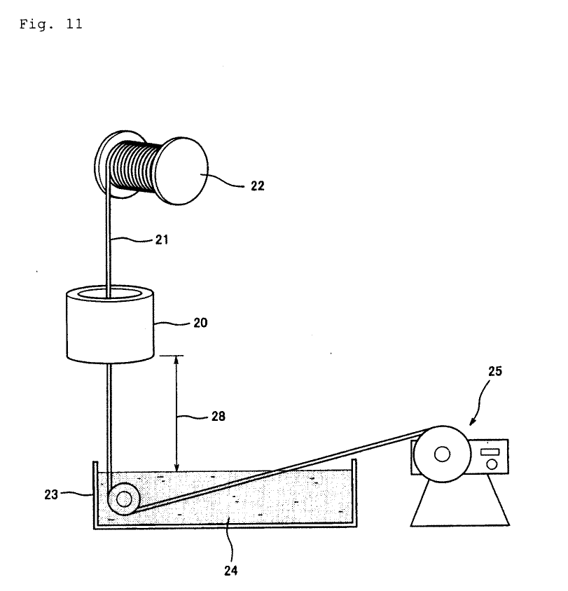

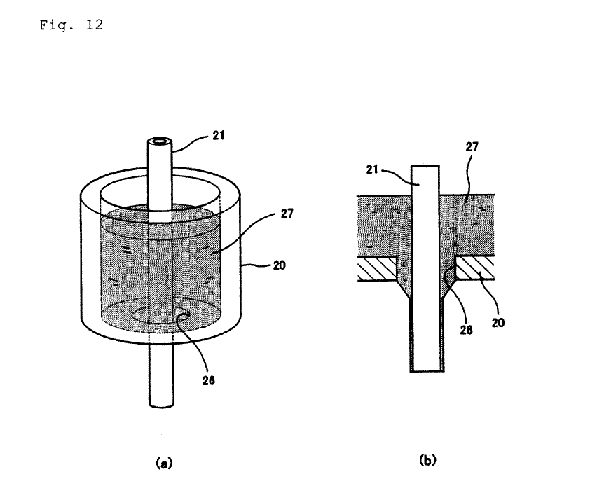

The water permeability of the hydrophilic filtration membrane of the present invention was measured using the apparatus for testing the amount of water permeation illustrated in the schematic view shown in FIG. 10. As is shown in this Figure, the apparatus for testing the amount of water permeation is constructed with a rotary pump 50, pressure gauges 51 and 52, a hollow fiber membrane 53 having a full length of about 150 mm, and a valve 54, with both ends of the hollow fiber membrane 53 fixed to pressure gauges 51 and 52 by injection needles 51a and 51b, respectively. A silicon tube 55 connects between the rotary pump 50 and the pressure gauge 51.

A predetermined amount of ion exchanged water was allowed to flow from inside the hollow fiber membrane 53 via the injection needle 51a using the rotary pump 50 at a flow rate of 0.6 ml/min for 3 min to obtain filtered water. In this procedure, the ion exchanged water not filtered was allowed to flow out via the injection needle 51b from the opposite end. The flow rate of the filtered water was measured using an electronic balance, and the injection pressure and the discharge pressure of the membrane were measured with the pressure gauges 51 and 52, respectively. One sample of the hollow fiber membrane 53 was subjected to the measurement four times, and the mean value of the four-times measurement was determined as the amount of water permeation of the sample. The dimensions such as the internal diameter and the external diameter of the hollow fiber membrane were measured using a scanning electron microscope (SEM). The amount of water permeation was calculated using the dimensions (full length, internal diameter) of the membrane, the measurement time period (3 min), the injection pressure value and the discharge pressure value, and the flow rate of the filtered water.

(Strength Test (Measurement of Stress, Strain and Young's Modulus)

Measurement of the physical strength of the polyethersulfone hollow fiber membrane of the present invention was carried out using a precision universal testing machine (manufactured by Shimadzu Corporation, Autograph AGS-J series). After a polyethersulfone membrane having a length of 50 mm was provided and fixed with a zipper, a load was applied to give a constant cloth head speed of 50 mm/min, and the maximum stress and the strain were measured. Young's modulus was calculated by data processing soft ware (manufactured by Shimadzu Corporation, TRAPEZIUM 2) based on the slope of the load-displacement curve.

TABLE 2

| | | | Comparative | Comparative | | | |
|---|---|---|---|---|---|---|---|
| | Example 2 | Example 3 | Example | Example | Example 4 | Example 5 | Example 6 |
| Water permeability | 375 | 205 | 388 | 196 | 7,686 | 13,107 | 14,487 |
| (l/m² · h · atm) | | | | | | | |
| Contact angle (degree) | 71.3 | 63.1 | 72.5 | 73 | — | — | — |
| Stress (MPa) | 2.19 | 3.82 | 3.53 | 3.94 | — | — | — |
| Strain (%) | 26.5 | 44 | 39.5 | 42.5 | — | — | — |
| Young's modulus (N/mm²) | 67.8 | 104.1 | 100.3 | 101 | — | — | — |

From the results shown in Table 2, it is revealed that any of the hollow fiber membranes of Examples 2 and 3, and Comparative Examples 2 and 3 had high water permeability, and particularly the hollow fiber membranes of Examples 4 to 6 strengthened with the reinforcing fiber had superior water permeability. In addition, the physical strength also reached a practically applicable level, and particularly the hollow fiber membranes of Examples 4 to 6 strengthened with the reinforcing fiber had significantly high physical strength.

### INDUSTRIAL APPLICABILITY

According to the dope solution of the present invention, a filtration membrane having high chemical resistance, high strength, high water permeability and high blocking performance, and having superior fouling resistance is obtained. Therefore, the present invention is applicable in the fields such as water supply business, food engineering field, medical field such as artificial dialysis treatments, and the like.

1. A hydrophilic filtration membrane comprising a hydrophilic polyethersulfone having a contact angle of 65 to 74 degree.

2. The hydrophilic filtration membrane according to claim 1, wherein the number of hydroxy groups in the hydrophilic polyethersulfone is 0.6 to 1.4 per 100 polymerization repeating units.

3. The hydrophilic filtration membrane according to claim 1, wherein the hydrophilic polyethersulfone has a molecular weight falling within the range of from 10,000 to 100,000.

4. The hydrophilic filtration membrane according to claim 1, further comprising polyvinylpyrrolidone.

5. The hydrophilic filtration membrane according to claim 4, wherein the polyvinylpyrrolidone has a molecular weight falling within the range of from 10,000 to 1,300,000.

6. The hydrophilic filtration membrane according to claim 1, which is reinforced with a reinforcing fiber.

7. A dope solution comprising a hydrophilic polyethersulfone having a contact angle of 65 to 74 degree, and a solvent.

8. The dope solution according to claim 7, wherein the number of hydroxy groups in the hydrophilic polyethersulfone is 0.6 to 1.4 per 100 polymerization repeating units.

9. The dope solution according to claim 7, wherein the hydrophilic polyethersulfone has a molecular weight falling within the range of from 10,000 to 100,000.

10. The dope solution according to claim 7, wherein the solvent is an organic solvent that allows the hydrophilic polyethersulfone to be dissolved, and is miscible with water.

11. The dope solution according to claim 7, further comprising a polyvinylpyrrolidone.

12. The dope solution according to claim 11, wherein the polyvinylpyrrolidone has a molecular weight falling within the range of from 10,000 to 1,300,000.

13. The dope solution according to claim 11, wherein the solvent is an organic solvent that allows the hydrophilic polyethersulfone and the polyvinylpyrrolidone to be dissolved, and is miscible with water.

14. A process for producing a hydrophilic filtration membrane, the process comprising allowing nonsolvent-induced phase separation to occur by charging the dope solution according to claim 7 into a membrane production bath solution that serves as a nonsolvent for the hydrophilic polyethersulfone.

15. The process for producing a hydrophilic filtration membrane according to claim 14, wherein the membrane production bath solution contains water.

16. The process for producing a hydrophilic filtration membrane according to claim 14, wherein the hydrophilic filtration membrane is a flat membrane, and the dope solution according to claim 7 is discharged from above the liquid level or into the liquid of the membrane production bath solution to give a form of a membrane using a discharge nozzle.

17. The process for producing a hydrophilic filtration membrane according to claim 14, wherein the hydrophilic filtration membrane is a hollow fiber membrane, and the dope solution according to claim 7 is discharged from above the liquid level or into the liquid of the membrane production bath solution to give a hollow fiber form using a multi-discharge nozzle, and concurrently an internal diameter-maintaining liquid is discharged from the center section of the multi-discharge nozzle into the center section of the hollow fiber.

18. The process for producing a hydrophilic filtration membrane according to claim 16, wherein a hydrophilic filtration membrane reinforced with a reinforcing fiber is obtained by discharging the dope solution together with the reinforcing fiber into the membrane production bath solution upon discharging the dope solution into a form of a membrane.

19. The process for producing a hydrophilic filtration membrane according to claim 14, wherein the hydrophilic filtration membrane is a hollow fiber membrane, and wherein a hollow fiber membrane reinforced with a reinforcing fiber is obtained by discharging the dope solution according to claim 7 together with a hollow reinforcing fiber from above the liquid level or into the liquid of the membrane production bath solution.

20. The process for producing a hydrophilic filtration membrane according to claim 19, wherein the reinforcing fiber is embedded inside the hollow fiber membrane.

21. A hydrophilic filtration membrane obtained by the process for production according to claim 14.
